(19) United States
(12) Patent Application Publication
(10) Pub. No.: US 2010/0018316 A1
(43) Pub. Date: Jan. 28, 2010

(54) NSMS flight laser detector cooling system

(75) Inventors: Allison Clark Nicklous, Moodus, CT (US); Edward F. Dreger, Burlington, CT (US); William F. Caswell, Baldwinsville, NY (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 12/220,421

(22) Filed: Jul. 24, 2008

(51) Int. Cl. G01H 9/00; H01S 3/04

(52) U.S. Cl. 73/655; 372/35

(57) ABSTRACT

A system includes a liquid cooling medium, a cooling plate having opposite first and second sides and at least one internal passage in which the liquid cooling medium flows, first and second lasers located adjacent to one another and positioned relative to the first side of the cooling plate, and a first Peltier device operably connected between the first side of the cooling plate and the first and second lasers for transferring thermal energy to the liquid cooling medium in the cooling plate.

### CROSS-REFERENCE TO RELATED APPLICATION(S)

The present invention is related to commonly-assigned U.S. patent application entitled “NSMS Flight Laser Detector System” filed on even date herewith, which is hereby incorporated by reference in its entirety.

### STATEMENT OF GOVERNMENT INTEREST

The present invention was developed, at least in part, under Contract No. N000019-02-C-3003 awarded by the United States Air Force. The U.S. Government has certain rights in this invention.

### BACKGROUND

The present invention relates to cooling systems for use with non-interference stress measurement systems (NSMSs), such as those used with gas turbine engines.

Non-interference stress measurement systems (NSMSs) are known for collecting structural data about gas turbine engine components (e.g., using blade vibration measurements correlated to blade stress) that is used, in turn, for engine design purposes and for engine certification processes. Typically, these NSMSs have been configured for test stand applications. In other words, these NSMSs have been configured to gather data from prototype or other non-airframe-mounted gas turbine engines in a test facility. These systems utilize optical sensors to measure stress in engine components, and relay those signals to ground-based electronics that process the data.

In some circumstances it is desirable or necessary to collect in-flight engine structural data while an engine is mounted to an airframe. However, known NSMSs generally cannot function in such in-flight situations due to high temperature conditions present in-flight. Moreover, many NSMSs are too large and heavy to be mounted to an airframe for use in-flight.

### SUMMARY

A system includes a liquid cooling medium, a cooling plate having opposite first and second sides and at least one internal passage in which the liquid cooling medium flows, first and second lasers located adjacent to one another and positioned relative to the first side of the cooling plate, and a first Peltier device operably connected between the first side of the cooling plate and the first and second lasers, for transferring thermal energy to the liquid cooling medium in the cooling plate.

### BRIEF DESCRIPTION OF THE DRAWINGS

FIG. 1 is a block diagram of a non-interference stress measurement system (NSMS).

FIG. 2 is an elevation view of a portion of the NSMS.

FIG. 3 is a cross-sectional view of the portion of the NSMS, taken along line 3-3 of FIG. 2, shown along with a schematic representation of a heat exchanger.

### DETAILED DESCRIPTION

In general, the present invention relates to a cooling system for use with a non-interference stress measurement system (NSMS) suitable for in-flight use on an airframe powered by a gas turbine engine. More particularly, the cooling system can include a housing in which various NSMS components are located. The housing can include one or more Peltier (i.e., thermoelectric) cooling units that help transfer thermal energy away from sensitive NSMS components to a cooling plate through which a liquid cooling medium (e.g., polyalphaolefin) passes. In this way, thermal energy can be absorbed by the liquid cooling medium, transported away from the housing by the liquid cooling medium, and then rejected from the liquid cooling medium at a remote location. The presence of the Peltier cooling units can help improve thermal energy transfer to the cooling plate, in order to help enhance cooling capabilities beyond those provided by only the cooling plate and liquid cooling medium. This allows the NSMS to reject heat generated by NSMS components and also heat absorbed due to relative high ambient temperatures, such as those common during in-flight conditions adjacent to a gas turbine engine supported by an airframe, which can help ensure temperature-sensitive NSMS components (e.g., lasers, optical detectors, etc.) operate efficiently during in-flight testing. The cooling system is relatively lightweight, and occupies a relatively small amount of space.

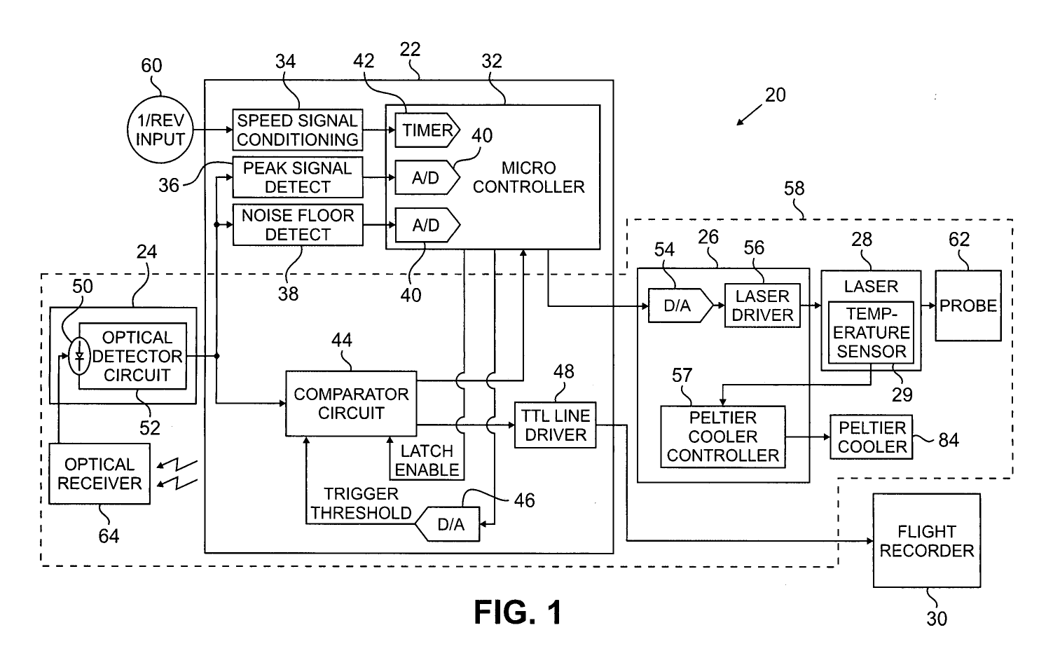

FIG. 1 is a block diagram of an exemplary NSMS 20 that includes a main circuit board 22, a detector circuit board 24, a laser/power circuit board 26, a laser 28 (e.g., a class 3B 350 mW laser) having a temperature sensor 29, and a flight recorder 30. The main circuit board 22 can include a conventional microcontroller 32 (e.g., a 32-bit, 120 MHz microcontroller), speed signal conditioning circuitry 34, peak signal detection circuitry 36, noise floor detector circuitry 38, analog-to-digital (A/D) converters 40, timer circuitry 42, a comparator circuit 44, a digital-to-analog (D/A) converter 46, and a transistor-to-transistor logic (TTL) line driver 48. The detector circuit board 24 can include an optical detector 50 and an optical detector circuit 52. The laser/power circuit board 26 can include a D/A converter 54, a laser driver 56, and a Peltier cooler controller 57. In alternative embodiments, the NSMS 20 can include additional components not shown in FIG. 1. For example, the components designated within box 58 can be replicated multiple times (e.g., with ten sets provided) within the NSMS 20, which can allow the provision of redundant components to maintain operation even in the event of failure of some components.

In operation, the NSMS 20 can gather data from rotating components, such as fan blades mounted on a rotor of a gas turbine engine in turn mounted to an airframe, and that data can be gathered while the airframe is in flight. A 1/REV input 60 is received from a sensor (e.g., a magnetic sensor configured to sense a flag on one of the fan blades), and is sent to the timer circuitry 42 of the microcontroller 32 via the speed signal conditioning circuitry 34 in order to determine a time for the rotating component to complete a single revolution. When testing a known number of rotating fan blades, the rotational time is divided by the number of fan blades in order to determine a blade interval time.

A power level supplied to the laser 28 by the laser driver 56 can be automatically adjusted during operation (and adjusted independently for each laser 28 in the NSMS 20). The laser power can be initially set at a specified level (e.g., approximately 20% of full power). After two revolutions of the rotor, for example, the peak signal detection circuitry 36 measures a reflected peak signal from the blade, and the laser power level is increased as necessary until the peak signal reaches a specified range (e.g., between approximately 3.7 to 4 volts). This procedure helps to account for the numerous variables that affect the amount of reflected energy sensed by the optical detector 50 for a given laser power setting.

Additionally, the laser 28 directs a beam of light to a probe 62 that focuses the beam of light toward the rotating fan blades, which is then reflected off the fan blades and collected by an optical receiver 64 that transmits the light to the optical detector 50 to be sensed. Optical fiber cables can connect the laser 28 to the probe 62 as well as the optical receiver 64 to the optical detector 50, for transmitting light to and from a location of the fan blades to a remote location where other NSMS 20 components are located. An analog output signal (e.g., a voltage signal) is then generated by the optical detector circuitry 52, which is sent to the microcontroller 22 via the peak signal detection circuitry 36 and the noise floor detection circuitry 38 and also to the comparator circuit 44. The microcontroller 32 analyzes the output signal and determines a trigger threshold as a function of information from the noise floor detection circuitry 38, which associates an amplitude of the output signal with an arrival of a fan blade. The comparator circuit 44 analyzes the output signal compared to the trigger threshold to determine the arrival of each fan blade. A square wave digital blade arrival signal (e.g., a TTL signal) indicating the arrival of each fan blade, as determined by the comparator circuit 44, is then generated by the comparator circuit 44 and the TTL line driver 48 and sent to the flight recorder 30 for storage. The stored information on the flight recorder 30 can be retrieved subsequent to in-flight testing. The analog output signal need not be stored, which can allow only analytical results to be stored, taking up far less memory than the storage of raw data for later analysis. The blade arrival signal (or TTL signal) can be used to measure blade vibration over time, and through comparison of data collected over time for a given fan blade at different circumferential locations (e.g., using sensors at different circumferential locations), fan blade stress levels can be assessed.

An active hold-off period can be triggered upon detection of the arrival of a fan blade, that is, when the output signal amplitude cross the trigger threshold. The active hold-off period can be a time period of approximately 60-90% of the blade interval time, such as 87.5% of the blade interval time. In this way, the exact length of time comprising the active hold-off period can vary as a function of the 1/REV input 60 for each revolution of the rotor carrying the fan blades, which in turn is a function of engine speed, making this an active, dynamic and automated determination rather than a passive, one-time and/or manual determination. During the active hold-off period, the output signal need not be analyzed, in effect allowing sensed optical data following the arrival of a given fan blade to be ignored until a time shortly before the arrival of an adjacent fan blade is expected. The active hold-off period helps reduce a risk of data errors, by reducing a risk of a waveform artifacts (e.g., a random spike in output signal amplitude) being confused with a blade arrival. For instance, light reflected off trailing edge portions of the fan blades can essentially be ignored, thereby reducing a risk of that trailing edge being confused with the arrival of the leading edge of the next fan blade. In prior art NSMSs, which were more like supervisory systems than analyzer systems, hold-off periods were set manually by a human operator using ground-based equipment, on generally a one-time basis, and the hold-off period was subject to operator-induced variation.

The blade arrival signal can be generated as a function of the triggering of the active hold-off period. For instance, the blade arrival signal can be latched to a “high” state upon triggering of an active hold-off period, then reset by command of the microcontroller 32 to a “low” state upon the completion of the active hold-off period. Further details of the operation of the NSMS 20 as found in commonly-assigned U.S. patent application entitled “NSMS Flight Laser Detector System” filed on even date herewith, which is hereby incorporated by reference in its entirety.

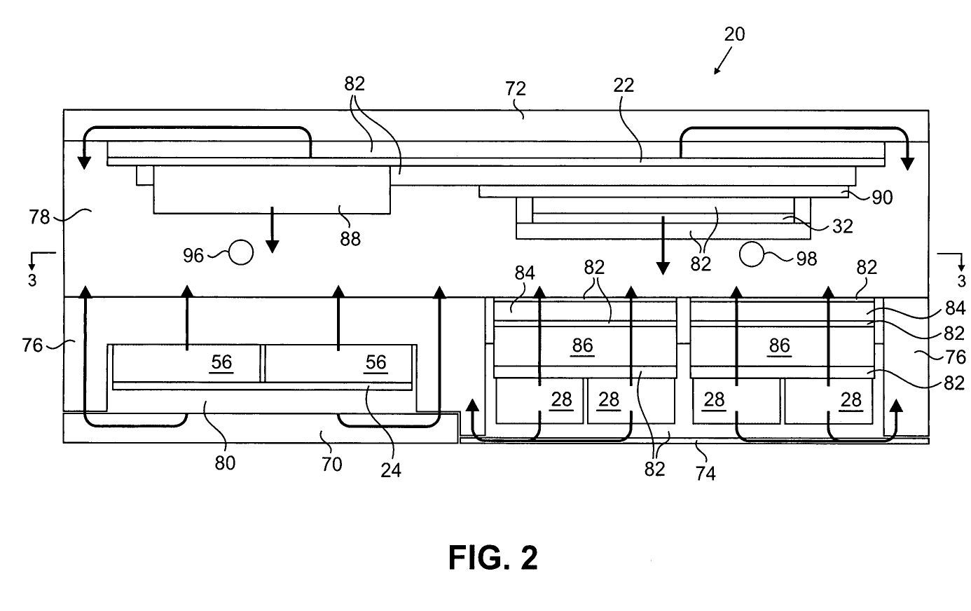

FIG. 2 is an elevation view of a portion of the NSMS 20. As shown in the illustrated embodiment, a housing is formed at least in part by first, second and third cover plates 70, 72 and 74, respectively, and a bottom plate 76. Components of the housing can be formed from a metallic material. A cooling plate 78 is located in between and in physical contact with the second cover plate 72 and the bottom plate 76. At a first side of the cooling plate 78, a plurality of laser drivers 56 are mounted on the laser/power circuit board 24, which in turn is mounted to the bottom plate 76 opposite the cooling plate 78. A thermally conductive gel 80 (e.g., “Gap Filler 1000 (Two Part)” available from The Bergquist Company, Chanhassen, Minn.) is located adjacent to the laser/power circuit board 24, against which the first cover plate 70 is positioned. A plurality of lasers 28 are positioned in between the cooling plate 78 and the third cover plate 74, adjacent to the bottom plate 76. Thermally conductive padding 82 (e.g., Gap Pad VO Soft® available from The Bergquist Company, Chanhassen, Minn.) is provided between the lasers 28, and between the lasers 28 and the third cover plate 74. Positioned between the lasers 28 and the cooling plate 78 are a plurality of Peltier (i.e., thermoelectric) cooling units 84 and copper plates 86. In the illustrated embodiment, one Peltier cooling unit 84 and one copper plate 86 are provided for every two lasers 28, with the copper plates 86 positioned between the Peltier cooling units 84 and the lasers 28, with additional thermally conductive padding 82 provided between each of those components.

At a second side of the cooling plate 78, a power supply 88 is positioned directly adjacent to the cooling plate 78. Adjacent to the power supply 88, the main circuit board 22 is positioned between the cooling plate 78 and the second cover plate 72, with more thermally conductive padding 82 provided between those components. The microcontroller 32 is positioned next to the power supply 88, between the cooling plate 78 and the second cover plate 72, with a microcontroller cover 90 positioned between the second cover 72 and the microcontroller 32. Additional thermally conductive padding 82 is provided at opposite sides of the microcontroller 32.

During operation, thermal energy is generated by the NSMS 20, and the NSMS 20 is also exposed to relatively high ambient temperatures. The NSMS 20 according to the present invention therefore provides a cooling system to help maintain suitable operating temperatures. Generally, thermal energy is rejected from the various NSMS 20 components to the cooling plate 78. As illustrated in FIG. 2, arrows denote the conductive transfer of thermal energy within the NSMS 20. The Peltier cooling units 84 actively transfer thermal energy from the lasers 20 to the cooling plate 78. Typically, the lasers 28 are particularly thermally sensitive, and have a thermal operating efficiency level at relatively low temperatures (compared to ambient temperatures in a gas turbine engine in fight). The Peltier cooler controller 57 can control operation of the Peltier cooler units 84 as a function of temperature data sensed by the temperature sensor 29 mounted to the laser 28 (see FIG. 1), in order to help the laser 28 operate within a desired temperature range. Thermal energy absorbed by the cooling plate 78 is then transferred to a liquid cooling medium, such as polyalphaolefin (often abbreviated as PAO), that can be passed through the cooling plate 78.

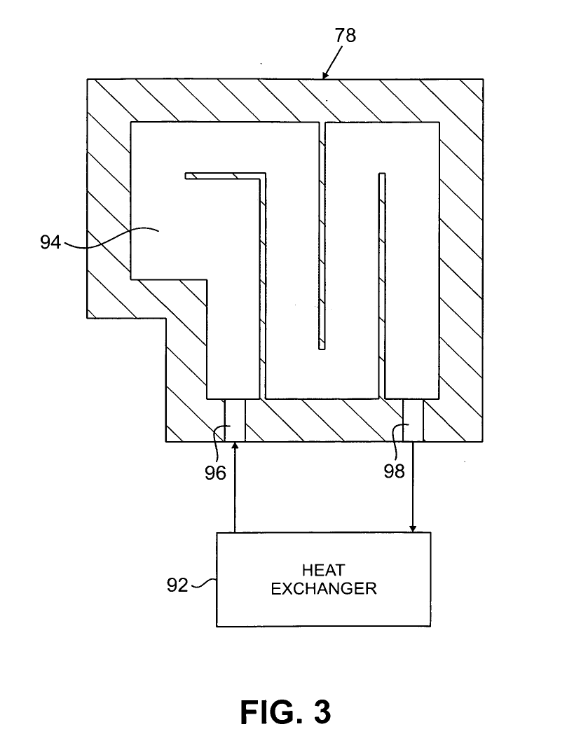

FIG. 3 is a cross-sectional view of the cooling plate 78, taken along line 3-3 of FIG. 2, shown along with a schematic representation of a heat exchanger 92 located remotely from the NSMS 20. The cooling plate 78 defines an internal passage 94 connected between an inlet 96 and an outlet 98. In the illustrated embodiment, the internal passage 94 has a serpentine shape, in order to increase a surface area of the cooling plate 78 exposed to the liquid cooling medium flowing therein. A cooling circuit is defined between the cooling plate 78 and the heat exchanger 92. The liquid cooling medium leaving the outlet 98 carrying a relatively high amount of thermal energy is transported to the heat exchanger 92 by suitable conduits, where thermal energy is removed from the liquid cooling medium and dissipated (e.g., to ambient air). The cooled liquid cooling medium is then directed from the heat exchanger 92 through suitable conduits to the inlet 96 in the cooling plate 78. The heat exchanger 92 can be of a conventional type for dissipating heat from a liquid.

It will be recognized that the present invention provides numerous advantages. For example, the cooling system can allow NSMS data collection during in-flight conditions, in environments with relatively high ambient temperatures where prior art systems could not survive or function efficiently. Moreover, the use of a liquid cooling medium along with Peltier coolers allows a relatively large amount of thermal energy to be dissipated from the NSMS, including the dissipation of ambient thermal energy absorbed by the NSMS. Additionally, the arrangement of components of the present invention, with a centrally located cooling plate and sensitive components arranged at opposite sides of the cooling plate, can provide a relatively compact and lightweight overall system (e.g., under approximately 13.6 kg (30 lbs.) excluding the heat exchanger) that is readily able to be carried on an airframe for in-flight testing, which is particularly important where airframe space is limited.

Although the present invention has been described with reference to preferred embodiments, workers skilled in the art will recognize that changes may be made in form and detail without departing from the spirit and scope of the invention. For instance, the cooling system of the present invention can be applied to NSMSs have different configurations that the illustrated embodiment.

1. A system comprising:
a liquid cooling medium;
a cooling plate having opposite first and second sides and at least one internal passage in which the liquid cooling medium flows;
first and second lasers located adjacent to one another and positioned relative to the first side of the cooling plate; and
a first Peltier device operably connected between the first side of the cooling plate and the first and second lasers for transferring thermal energy to the liquid cooling medium in the cooling plate.

2. The system of claim 1 and further comprising:
thermal padding located between the first and second lasers and the first Peltier device.

3. The system of claim 1, wherein the liquid cooling medium comprises polyalphaolefin.

4. The system of claim 1 and further comprising:
third and fourth lasers located adjacent to one another and positioned relative to the first side of the cooling plate; and
a second Peltier device operably connected between the first side of the cooling plate and the third and fourth lasers.

5. The system of claim 4 and further comprising:
thermal padding located between the third and fourth lasers and the second Peltier device.

6. The system of claim 1 and further comprising:
a first laser driver located relative to the first side of the cooling plate and operatively connected to the first laser.

7. The system of claim 1 and further comprising:
a micro controller located relative to the second side of the cooling plate and operatively connected to the first laser driver.

8. The system of claim 1 and further comprising:
a heat exchanger located remotely from the cooling plate for dissipating thermal energy from the liquid cooling medium.

9. A method comprising:
rotating a gas turbine engine component;
directing a beam from a laser at the rotating gas turbine engine component;
sensing vibration of the rotating gas turbine engine component as a function of reflected light of the beam;
passing a liquid cooling medium through a cooling plate positioned adjacent to the laser; and
transferring thermal energy from the laser to the liquid cooling medium in the cooling plate with a Peltier device.

10. The method of claim 9, wherein the laser is located in a high temperature environment, and wherein the step of transferring thermal energy from the laser to the liquid cooling medium reduces an effect of the high temperature environment on an operating temperature of the laser.

11. The method of claim 9 and further comprising:
removing thermal energy from the liquid cooling medium at a location remote from the laser.

12. A system comprising:
an airframe;
a rotatable component supported by the airframe;
a plurality of lasers supported by the airframe and located adjacent to the rotatable component;
a plurality of optical detectors positioned adjacent to the rotating component for sensing vibration as a function of light from the plurality of laser reflected off the rotatable component;
a cooling plate located adjacent to the plurality of lasers;
a liquid cooling medium flowable through an interior passage of the cooling plate for absorbing thermal energy from the cooling plate;
a first Peltier device configured to transfer thermal energy from at least one of the plurality of lasers to the cooling plate.

13. The system of claim 12 and further comprising:
thermal padding located between the plurality of lasers and the first Peltier device.

14. The system of claim 12, wherein the liquid cooling medium comprises polyalphaolefin.

15. The system of claim 12 and further comprising:
a second Peltier device operably connected between at least one of the plurality of lasers.

16. The system of claim 15 and further comprising:
thermal padding located between the plurality of lasers and the second Peltier device.

17. The system of claim 12 and further comprising:
a laser driver located relative to a first side of the cooling plate and operatively connected to one of the plurality of lasers also located relative to the first side of the cooling plate.

18. The system of claim 17 and further comprising:
a micro controller located relative to a second side of the cooling plate and operatively connected to the laser driver.

19. The system of claim 12 and further comprising:
a heat exchanger supported by the airframe and located remotely from the cooling plate for dissipating thermal energy from the liquid cooling medium.

20. The system of claim 12, wherein the rotatable component comprises a blade for a gas turbine engine.
